(19) United States
(12) Patent Application Publication
(10) Pub. No.: US 2012/0117364 A1
(43) Pub. Date: May 10, 2012

(54) Method and System for Operating a Handheld Calculator

(76) Inventors: Russell Melvin Rosenquist, Plano, TX (US); Robert Allen Lorentzen, Carrollton, TX (US)

(21) Appl. No.: 12/939,686

(22) Filed: Nov. 4, 2010

(51) Int. Cl. G06F 15/177; G06F 1/26

(52) U.S. Cl. 713/2; 713/300

(57) ABSTRACT

A method for operating a handheld calculator having a controllable power domain is provided. The method includes receiving, by the handheld calculator, a signal to power down the handheld calculator, storing context information of at least one component in the controllable domain in an external memory, setting a boot indicator to indicate a quick boot on power up, and removing power from the controllable power domain.

### BACKGROUND OF THE INVENTION

An important design goal of handheld battery-powered devices (e.g., calculators, PDAs, etc.) is to provide “instant-on” capability while minimizing power consumption required to provide this capability. The instant-on capability allows a user to quickly power-up a device in the state it was in when powered down without a long boot-up time. Delivering on this feature while preserving (or maximizing) battery life has become more and more challenging as CMOS IC technology process geometries have become smaller and smaller.

In the past few decades, CMOS technology, due to its extremely low static state power consumption, allowed designers to keep all circuits, processors, memories, etc. in a device powered, even when the device is turned off. This was accomplished by simply stopping or disabling clocks in the device when the user turns the device off. The device could then be returned to immediate and fully operational mode by simply restarting the clocks (without having to go through any type of re-boot process to restore operating state) when the user turned the device on.

However, the continued advancement of CMOS IC technology has led to a significant increase in static state power consumption, which can have detrimental impact to the battery life of a device. Thus, in order for designers to take advantage of the latest CMOS technology advancements while continuing to deliver on instant-on capabilities and providing adequate battery life, new design approaches are needed.

### BRIEF DESCRIPTION OF THE DRAWINGS

Particular embodiments in accordance with the invention will now be described, by way of example, and with reference to the accompanying drawings:

FIG. 1 is a block diagram of a handheld calculator in accordance with one or more embodiments of the invention;

FIG. 2 is a block diagram of hardware components of the handheld calculator of FIG. 1 in accordance with one or more embodiments of the invention;

FIG. 3 is a block diagram of a software system executable on the calculator of FIGS. 1 and 2 in accordance with one or more embodiments of the invention;

FIGS. 4-6 are sequence diagrams in accordance with one or more embodiments of the invention; and

FIGS. 7 and 8 are flow graphs of methods in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components and modules of computer and handheld calculator systems may be referred to by different names and/or may be combined in ways not shown herein without departing from the described functionality. This document does not intend to distinguish between components/modules that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless connection. Thus, if a first device couples to a second device, that connection may be through a direct connection, through an indirect connection via other devices and connections, through an optical connection, and/or through a wireless connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps and/or number of steps shown in the figures and/or described herein.

Embodiments of the invention provide for “instant on” functionality in handheld battery-powered devices such as calculators. More specifically, in embodiments of the invention, various hardware components are arranged into two power domains such that when the device is turned off, one power domain will remain powered and the other, i.e., the controllable power domain, will have power removed. The assignment of components to the power domains may be made such that static current is minimized while the device is turned off but sufficient components remain powered to be able to quickly, e.g., in less than one second, restore the state of the device when it was turned off when the device is turned on. Further, a power-down sequence is provided that is executed when the device is turned off. This power-down sequence stores the relevant state, i.e., context, of the device, sets a boot indicator to indicate that the device state has been stored, and causes power to be removed from the controllable power domain. A power-up boot sequence, i.e., a quick boot sequence, is also provided that is executed when the device is turned on when the boot indicator indicates that there is a stored device state. This quick boot sequence causes power to be restored to the controllable power domain and restores the state of the device. At least one additional boot sequence, i.e., a cold boot sequence, may also be provided that is executed when the device is turned on and the boot indicator indicates that there is not a stored device state, e.g., when the device is turned on after all power has been removed from the device by, for example, removal and insertion of batteries. This cold boot sequence performs a full system initialization process.

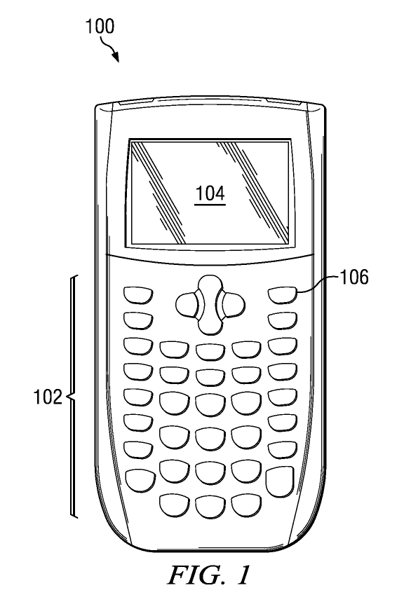

FIG. 1 shows a handheld calculator (100) configured to boot in accordance with one or more embodiments of the invention. For illustrative purposes, the handheld calculator shown in FIG. 1 is similar to graphing calculators available from Texas Instruments, Inc. As shown in FIG. 1, the handheld calculator (100) includes a graphical display (104) and a set of keys (102). The graphical display (104) may be used to display outputs of processes executing on the handheld calculator (100). The graphical display (104) may be, for example, an LCD display. The set of keys (102) allows a user to enter data and to start and interact with the processes executing on the handheld calculator (100). The on/off key (106) allows a user to turn the handheld calculator (100) on and off which activates, respectively, power up and power down sequences as described herein. The handheld calculator (100) may include a central processing unit (CPU), memory, a power supply, and other hardware components that provide functionality beyond the minimum calculator functions.

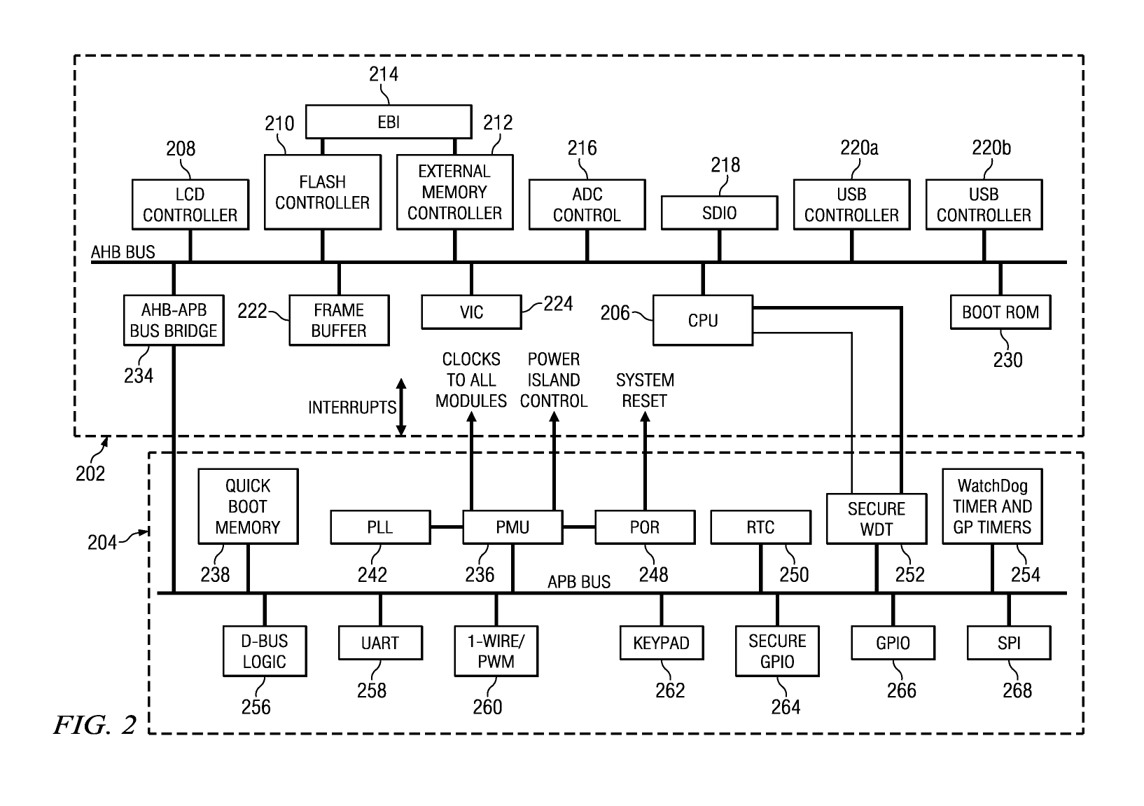

FIG. 2 is a block diagram illustrating in more detail hardware components that may be incorporated in the handheld calculator (100). In one or more embodiments of the invention, the illustrated hardware components may be packaged in an application specific integrated circuit (ASIC). The components are organized into two power domains, i.e., power islands, a controllable power domain (202) and a non-controllable power domain (204). The controllable power domain (202) is a power domain that can have power removed from/restored to the components in the power domain while other components in the handheld calculator (100) remain powered. Further, power may be removed from the controllable power domain (202) while retaining power for other components in response to the user turning the handheld calculator (100) off using the on/off key (106). In some embodiments of the invention, power may be removed from the controllable power domain (202) in response to an automatic power down (APD) of the handheld calculator (100) after the calculator has been idle for some period of time. The length of the idle time period may be configurable by the user. Power may be restored to the controllable power domain (202), for example, in response to the user turning the handheld calculator (100) on using the on/off key (106). The non-controllable power domain (204) is a power domain that remains powered at all times power is available in the handheld calculator (100), e.g., while charged batteries are installed.

The controllable power domain (204) includes the following components: an LCD controller (208), a flash memory controller (210), an external memory controller (212), an external bus interface (EBI) (214) to external, i.e., off-chip, memory, an analog-to-digital converter (ADC) control (216), a secure digital input/output interface (SDIO) (218), universal serial bus (USB) controllers (220), a boot ROM (230), a frame buffer (222), a vector interrupt controller (VIC) (224), an AHB-APB bus bridge (234), and a CPU (206). These components are all connected by an AHB bus. As is well-known in the art, an AHB bus is an advanced microprocessor bus architecture (AMBA) high performance bus designed to be used on-chip.

The non-controllable power domain (204) includes the following components: a power management unit (236), a quick boot memory (238), a phase locked loop (PLL) component (242), a power on reset (POR) component (248), a real-time clock (RTC) (250), a secure watchdog timer (252), a non-secure timer component (254), a keypad interface component (262), and various other peripheral interfaces including serial ports (258, 268), general purpose input/output interfaces (264, 266), a battery monitoring interface (260), and an interface for connecting the calculator to a computer (256). These components are all connected by an APB bus. As is well-known in the art, an APB bus is an AMBA advanced peripheral bus designed to be used on-chip.

The general functionality of many of the components listed above will be understood by one of ordinary skill in the art and is not described herein. The frame buffer (222) is on-chip memory, e.g., static random access memory (SRAM), used as a frame buffer by the LCD controller (208). In one or more embodiments of the invention, the size of the frame buffer (222) is 78 KB. The external memory controller (212) controls accesses to external memory, e.g., synchronous dynamic random access memory (SDRAM). The external memory may be any suitable memory that can retain its contents with minimal power consumption when the external memory controller (212) is disabled. For example, SDRAM may be placed in a self-refresh mode in which a timer generates internal refresh cycles as needed to retain contents. This mode allows the memory controller to be disabled entirely and the clock may also be stopped.

The boot ROM (230) is read only memory that stores the initial part of the boot code for the handheld calculator (100). As is explained in more detail below, this initial boot code includes functionality to determine whether a quick boot or a cold boot is to be performed. If a cold boot is indicated, the initial boot code validates and loads into the external memory a secondary part of the boot code stored in external flash memory and transfers control to the secondary part. If a quick boot is indicated, the initial boot code performs validations as described in more detail below, and transfers control to a recovery routine stored in the external memory. In one or more embodiments of the invention, the size of the boot ROM (230) is 128 KB. The flash controller (210) controls accesses to external flash memory, e.g., NAND and/or NOR flash memory. The external flash memory stores the secondary part of the boot code that is responsible for initializing the file system and validating and loading the operating system. The external flash memory stores the operating system code and may also store applications to be executed on the handheld calculator (100).

The quick boot memory (238) is an internal memory, e.g., SRAM, used to store quick boot data, e.g., validation data, the address of a resume function stored in the external memory, etc., generated during the power-down sequence and a boot indicator that is used by the boot code stored in the boot ROM (230) to determine whether a quick boot or a cold boot is to be performed. The quick boot memory (238) is also used to execute portions of the power-down sequence. In one or more embodiments of the invention, the size of the quick boot memory (238) is 2 KB.

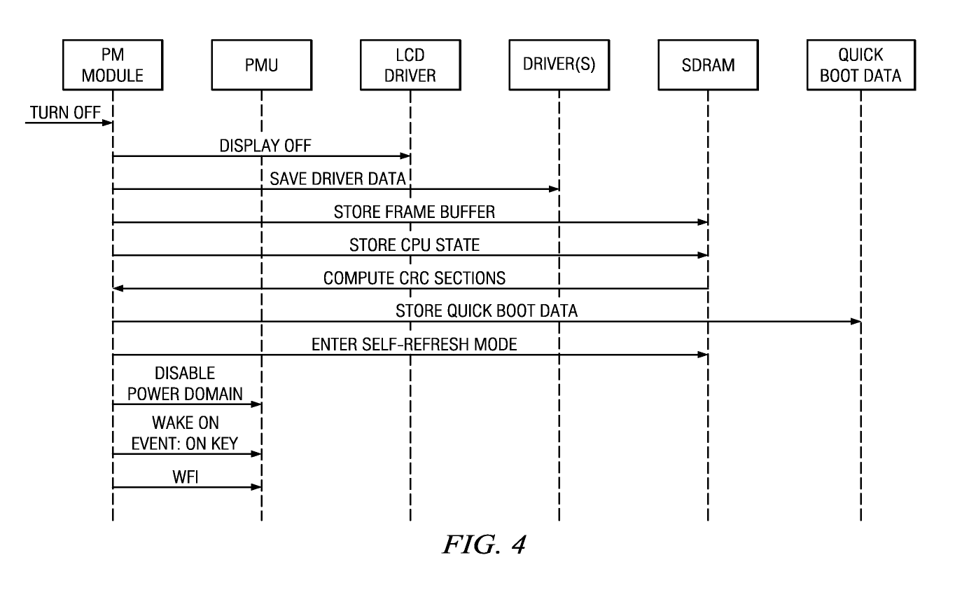

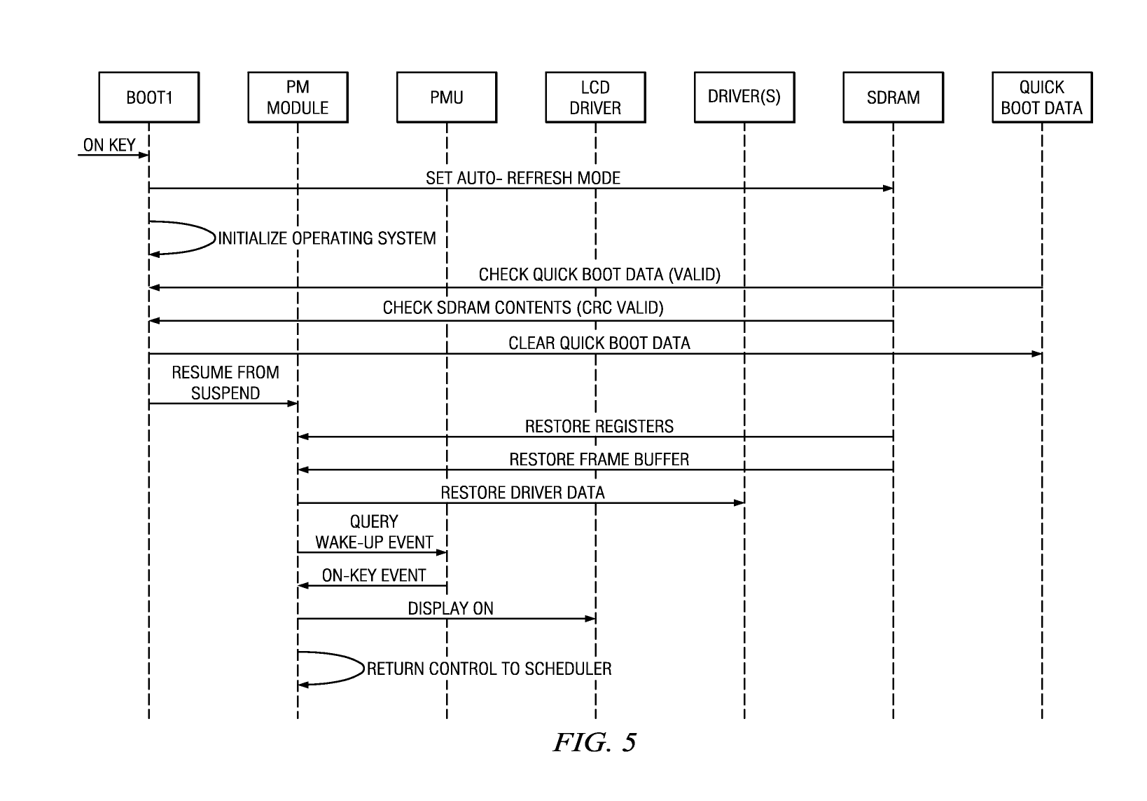

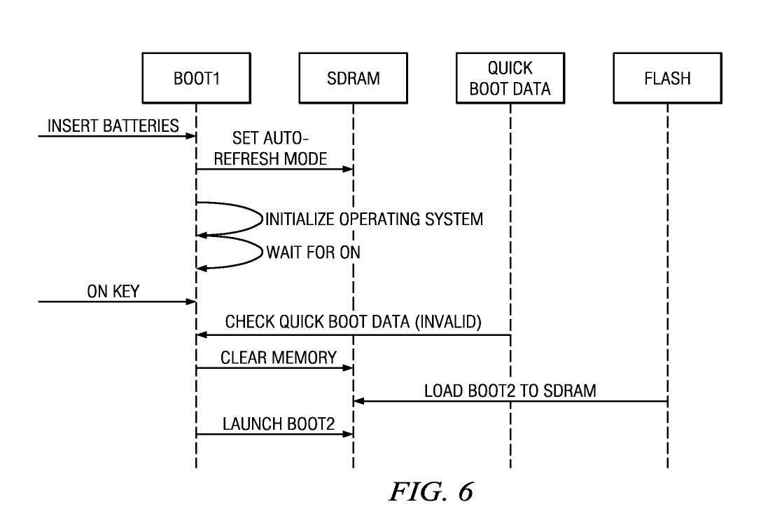

In one or more embodiments of the invention, when the user presses the on/off key (106) to turn the handheld calculator (100) off, the power-down sequence is executed to save the state of the calculator and to remove power from the controllable power domain (202). In some embodiments of the invention, the power-down sequence is also executed after a period of inactivity. The length of this inactivity period may be user configurable. An example power-down sequence is described in more detail below in reference to FIG. 4. Further, when the user presses the on/off key (106) to turn the handheld calculator (100) back on, the quick boot sequence is executed to restore the state of the calculator and restore power to the controllable power domain (202). An example quick boot sequence is described in more detail below in reference to FIG. 5. In addition, when the user presses the on/off key (106) to turn on the handheld calculator (100) after all power has been removed from the calculator, e.g., after loss of battery power, the cold boot sequence is executed to perform a full system initialization. An example cold boot sequence is described in more detail below in reference to FIG. 6.

The PMU (236) includes functionality to manage the dynamic and state power consumption of the handheld calculator (100). More specifically, the PMU (236) includes functionality to turn the controllable power domain (202) on and off and for enabling and disabling clocks to individual modules including the CPU (206). The PMU (236) also provides for power management in three modes of operation: active, i.e., when the handheld calculator (100) is powered up and in use, standby, e.g., when waiting for user input, and power down, i.e., when the handheld calculator (100) is powered down and state is to be retained for a quick boot. The standby mode and the power down mode are entered by commands issued to the PMU (236) and are exited based on wake up events specified before entering the mode. As is explained in more detail below, the power down mode is set in the PMU (236) during the power down sequence. In addition, the power down sequence also sets the wake up events for this mode. Wake-up events can be from a number of sources such as timers (252, 254), the RTC (250), GPIO (266), the keypad (262), etc. For example, when the quick boot sequence is executed in response to the on/off key (106), the depression of the key causes a wake up event that causes the PMU (236) to perform power management functions to return the calculator to an operational state.

The POR component (248) includes functionality to provide a valid reset to the CPU (206) and other components when a wake-up event occurs. The POR component (248) provides the reset responsive to a system reset request from the PMU (236).

In one or more embodiments of the invention, when a system wake-up event is detected by the PMU (236), the PMU (236) immediately enables power to the controllable power domain (202), enables the PLL (242) and system clocks, and sends a system reset request to the POR component (248). The POR (248) then issues a system reset signal to the CPU (206) and other system components after the power and clocks have had sufficient time to stabilize.

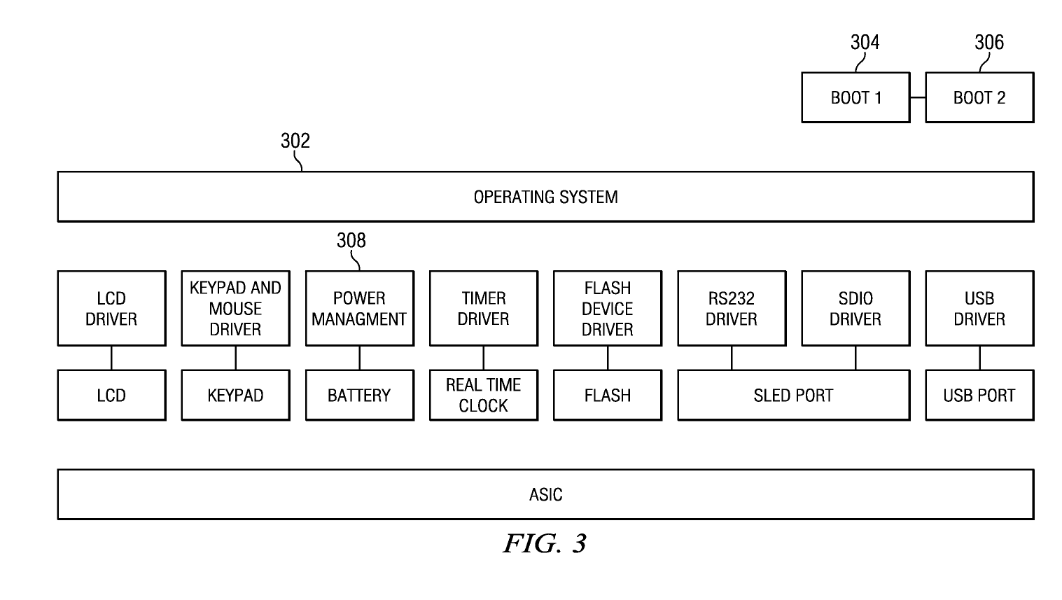

FIG. 3 is a block diagram illustrating some of the software modules of the handheld calculator (100) in accordance with one or more embodiments of the invention. The general functionality of many of the software components shown in FIG. 3 will be understood by one of ordinary skill in the art and is not described herein. As shown in FIG. 3, the handheld calculator (100) includes an operating system (302), an initial boot module Boot1 (304) stored in the boot ROM (230), a secondary boot module Boot2 (306) stored in external flash memory, a power management module (308), and various drivers for the hardware components of FIG. 2. The operating system (302) may be any suitable operating system, such as, for example, the Nucleus operating system available from Mentor Graphics Corporation. The initial boot module (304) includes functionality to determine whether a cold boot or a quick boot is to be performed based on a boot indicator stored in the quick boot memory (238). If a cold boot is indicated, the initial boot module (304) performs some initialization and then authenticates, loads, and executes the secondary boot module (306). The secondary boot module (306) includes functionality to complete the initialization of the calculator, including initializing the file system and validating and loading the operating system (302). An example cold boot sequence is described in more detail below in reference to FIG. 6.

If a quick boot is indicated, the initial boot module (304) initializes some of the hardware components, including the external memory controller (212). The initial boot module (304) also validates at least the part of the quick boot memory (238) that stores quick boot information generated by the power down sequence. In one or more embodiments of the invention, the quick boot information includes the boot indicator, the address of a resume function, and validation values, e.g., CRC (cyclic redundancy check) values, for selected sections of the external memory along with addresses of the selected sections. In one or more embodiments of the invention, the selected sections of external memory include sections where application code is stored, sections where variable values for applications are stored, and sections where the context information for the CPU (206) and for device controllers (e.g., 218, 220) in the controllable power domain (202) are stored during the power down sequence.

In some embodiments of the invention, the quick boot information may also include a “magic number.” The magic number is a number stored during the power down sequence to be used by the initial boot module (304) to validate the contents of the quick boot memory (238). More specifically, the magic number is used to detect whether power was removed from the handheld calculator (100) while the handheld calculator was in the power down mode. The value of the magic number may be any predetermined relatively large number, e.g., a number 32 to 64 bits in length. If the quick boot memory (238) is volatile memory such as SRAM, the removal of power from the quick boot memory (238), e.g., by loss of battery power in the handheld calculator (100), will cause the magic number to change. The magic number is checked by the initial boot module (304) and if the value is invalid, the quick boot information is presumed to be invalid and a cold boot is preformed.

If the validation of the quick boot memory (238) is successful, the initial boot module (304) also validates the selected sections of the external memory based on the validation values. If this validation is successful, the initial boot module (304) then transfers control to the specified resume function to complete the quick boot, e.g., to restore the context information from external memory, and transfer control back to normal operation. In some embodiments of the invention, the initial boot module (304) also clears the quick boot data in the quick boot memory (238) before transferring control to the resume function. An example quick boot sequence is described in more detail below in reference to FIG. 5.

The power management module (308) includes functionality for managing power in the handheld calculator (100) such as, for example, monitoring battery level and the battery door, detection of keypad activity, e.g., pressing of the on/off key (106), and APD. The power management module (308) also includes functionality for managing the power down sequence and for performing portions of the quick boot sequence. More specifically, the power management module (308) includes functionality to receive a signal to power down the handheld calculator (100), e.g., APD or pressing of the on/off key (106), and, responsive to the signal, to cause the actions needed to place the handheld calculator (100) in a state where a quick boot may be performed to restart the calculator. These actions may include turning the display (104) off, saving context, i.e., state information, of the various drivers of devices in the controllable power domain (202) in external memory (212) as needed and turning off the devices, storing the contents of the frame buffer (222) and the CPU (206) context, e.g., register contents, in external memory (212), computing validation data for the selected sections of the external memory (212) and storing the validation data in the quick boot memory (238), setting the boot indicator in the quick boot memory (238) to indicate a quick boot, and placing the external memory (212) in the lowest power mode that will retain memory contents, e.g., self-refresh. The power management module (308) also causes the PMU (236) to disable the controllable power domain (202), specifies the wake up event(s) for the PMU (236), e.g., pressing of the on/off key (106), and causes the PMU (236) to enter a state waiting for the specified wake up event(s). An example power down sequence is described in more detail below in reference to FIG. 4.

The actions of the power management module (308) for managing portions of the quick boot sequence may include restoring the CPU (206) registers and the frame buffer from external memory (212), restoring the driver data of the various drivers of the devices in the controllable power domain (202) from external memory (212), turning the display (104) on, and returning control to the scheduler of the operating system (302).

FIG. 4 is a sequence diagram of an example power down sequence for the handheld calculator (100) of FIGS. 1-3. In this example, and the subsequent examples, the external memory (212) is assumed to be SDRAM. The power down sequence is initiated when the power management module (PM module) receives an indication that the calculator is to be powered down. This indication may result, for example, from the user pressing the on/off key (106) and/or APD. The PM module then causes the LCD driver to turn off the display, iterates through the drivers of the devices in the controllable power domain (202) to cause the drivers to save device context as needed in the SDRAM. The PM module also stores the contents of the frame buffer and the CPU state in SDRAM. The PM module then computes CRCs of the selected sections of SDRAM and stores the CRCs and the locations of the selected sections in the quick boot memory, stores other data needed for the quick boot sequence in the quick boot memory including setting the boot indicator to indicate a quick boot and storing the address of the resume function. The PM module may also store a magic number (previously described herein) as part of the quick boot data. The PM module then causes the SDRAM to enter self-refresh mode, which is the lowest power state of the SDRAM that will retain contents. Finally, the PM module interacts with the PMU to disable the controllable power domain, to set the PMU wake up event to be pressing of the on/off key (106), and to cause the PMU to wait for the wake up interrupt.

FIG. 5 is a sequence diagram of an example quick boot sequence for the handheld calculator (100) of FIGS. 1-3. The quick boot sequence is initiated when the Boot1 module is activated responsive to pressing of the on/off key (106). Power to the controllable power domain (202) is also reactivated responsive to pressing of the on/off key (106). The Boot1 module then causes the SDRAM to enter auto-refresh mode, i.e., to return to full power mode, and initializes the operating system. In one or more embodiments of the invention, the operating system initialization includes initialization of the registers, kernel parameters, and essential drivers needed for Boot1 operation. Boot1 then validates the quick boot data stored in the quick boot memory using the magic number stored during the power down sequence. Assuming the quick boot data is valid, Boot1 then validates the selected sections of SDRAM using the CRC values and locations stored in the quick boot memory. Assuming the SDRAM validation is successful, Boot1 then clears the quick boot data in the quick boot memory, and passes control to the PM module to complete the quick boot sequence. The address of the function in the PM module to be called is stored as the resume function address during the power down sequence. The PM module then restores the CPU state and the frame buffer from SDRAM. Subsequently, the PM module iterates through the drivers of the devices in the controllable power domain, causing the drivers to restore the states of their associated devices from SDRAM as needed. The PM module then queries the wake-up event from the PMU to determine the type of the wake-up event as some wake-up events may require additional processing. In this example, the PMU indicates that the wake-up event was pressing of the on/off key (106) so no additional processing is needed. The PM module then turns on the display and returns control the operating system scheduler.

FIG. 6 is a sequence diagram of an example cold boot sequence for the handheld calculator (100) of FIGS. 1-3. The cold boot sequence is initiated when the Boot1 module is activated responsive to restoration of power to the handheld calculator (100), e.g., after battery replacement or recharging. The Boot1 module then causes the SDRAM to enter auto-refresh mode, i.e., to return to full power mode, and initializes the operating system as previously described. Boot1 then waits for the on/off key (106) to be pressed indicating that the user wishes to use the calculator. When the key is pressed, Boot1 checks the boot indicator in the quick boot data stored in the quick boot memory. The boot indicator will indicate a cold boot. Boot1 then clears the SDRAM, loads Boot2 in the SDRAM, and transfers control to Boot2 to complete the booting process.

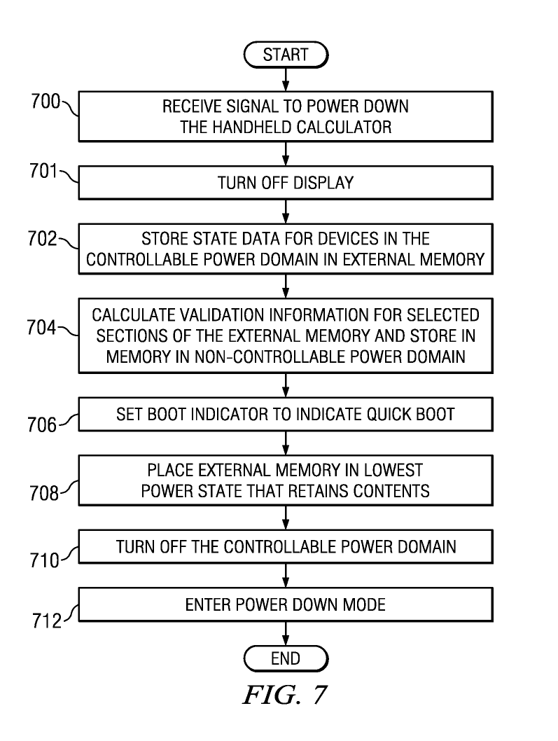

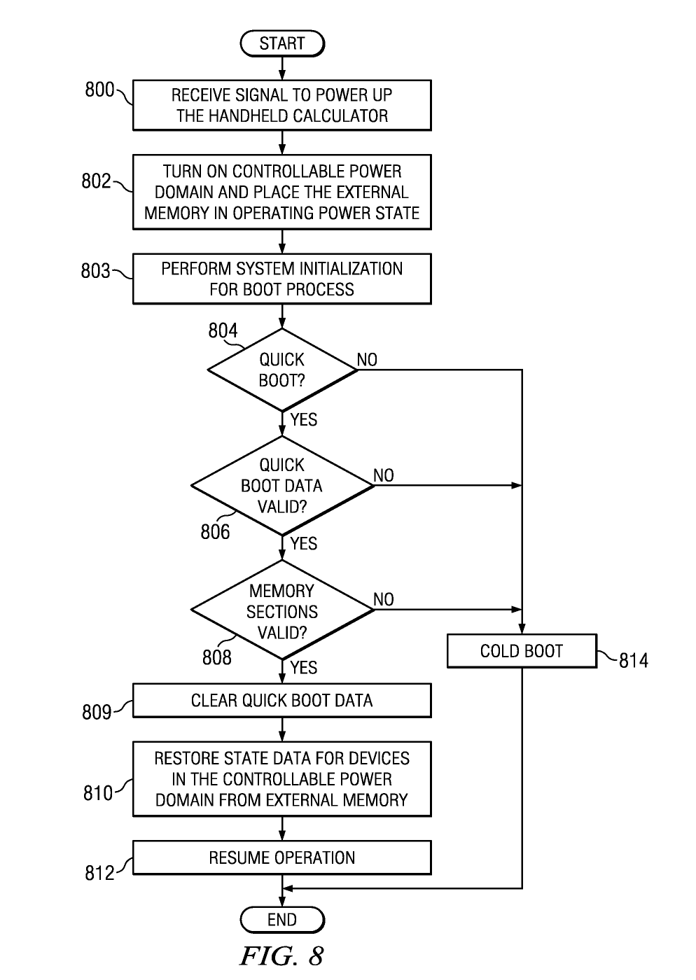

FIGS. 7 and 8 are flow diagrams of a method for powering down a handheld calculator and for booting the handheld calculator, respectively. These methods assume that most of the components of the handheld calculator are arranged into two power domains, a controllable power domain from which power may be removed when the calculator is powered down, and a non-controllable power domain that remains powered when the calculator is power down. The handheld calculator also includes an external memory that may be placed in a low power state that retains contents while consuming minimal power and an operational power state for use when the calculator is powered up. The choice of which components are included in each of the power domains is a design decision based on a tradeoff between reducing static power consumption when the calculator is powered down versus speed of resuming operation of the calculator at the state it was in when it was powered down.

In one or more embodiments of the invention, the non-controllable power domain includes a small memory for storing data needed for the quick boot process, sufficient circuitry for detecting a power up signal from an on/off key, sufficient circuitry for controlling the power state of an external memory, and sufficient circuitry for initiating the boot process. In some embodiments of the invention, other circuitry is included in the non-controllable power domain. In one or more embodiments of the invention, the controllable power domain includes the CPU, on-chip memory, a display controller, one or more memory controllers, e.g., an external memory controller and/or a flash memory controller, and/or controllers for other devices.

Referring now to FIG. 7, the method for powering down the handheld calculator begins with receiving a signal to power down the calculator (700). This signal may result from, for example, the user pressing an on/off key to turn the calculator off or from an automatic power down executed after the calculator has been idle for a period of time. The display is then turned off (701) and state data for the devices in the controllable power domain is stored in the external memory (702). This state data includes any data that is needed to restore the calculator the current operational state when the calculator is turned on after the power down. The state data may include, for example, contents of CPU registers, context data for the devices having controllers in the controllable power domain, the contents of any on-chip memory, e.g., a frame buffer for the display, etc.

Next, validation information for selected sections of the external memory is calculated and stored in a memory in the non-controllable power domain (704). The validation information may be calculated in any suitable way. In one or more embodiments of the invention, a CRC value is calculated for each of the selected section. The selected sections may include any memory sections that are needed for resuming operation of the calculator, such as, for example, sections where the state data is stored, sections where executable code is stored, sections where variable values are stored, etc. Location information, e.g., an address, an offset, etc., for each of the selected sections is also stored in this memory in association with the validation information. This validation information with associated location information may be referred to as quick boot data. In some embodiments of the invention, a pointer to a resume function and/or a magic number as previously described may also be stored in the memory in the non-controllable power domain.

A boot indicator in the non-controllable power domain is also set to indicate that a quick boot is to be performed when the calculator is powered up (706). In some embodiments of the invention, the boot indicator is stored in the memory in the non-controllable power domain. The external memory is then placed into the lowest power state that will allow the memory to retain its current contents, e.g., self-refresh (708). Finally, the controllable power domain is turned off (710) and the calculator enters a power down mode waiting for a power up signal.

Referring now to FIG. 8, the method for booting the handheld calculator begins with receiving a signal to power up the calculator (800). This signal may result from, for example, the user pressing an on/off key to turn the calculator on or from the insertions of new batteries. Upon receipt of this signal, the controllable power domain is turned on and the external memory is set to its operating power state, e.g., auto-refresh (802). System initialization is also performed for the boot process (803). This system initialization the hardware and software needed by the boot process. Next, the boot indicator is checked to see if a quick boot is indicated (804). If not, a cold boot is performed (814). If a quick boot is indicated, quick boot data stored in the memory in the non-controllable power domain is validated (806). If the data is not valid, a cold boot is performed (814). Otherwise, the selected sections of the external memory are validated using the validation information stored during power down (808). If these sections are not valid, a cold boot is performed (814). Otherwise, the quick boot data in the non-controllable power domain is cleared (809) and state data for the devices in the controllable power domain is restored from the external memory (810). The quick boot data in the non-controllable power domain is then cleared and operation of the calculator is resumed in the state it was in when it was powered down (812).

While the invention has been described with respect to a limited number of embodiments, those skilled in the art, having benefit of this disclosure, will appreciate that other embodiments can be devised which do not depart from the scope of the invention as disclosed herein. For example, one skilled in the art will appreciate that embodiments of the invention may be implemented in battery-powered devices other than handheld calculators, such as, for example, personal digital assistants (PDAs), cellular telephones, MP3 players, netbook computers, laptop computers, etc. In another example, one skilled in the art will appreciate embodiments of the invention having fewer or more hardware components than those described herein and having more, fewer, and/or different hardware components allocated between the two power domains. Accordingly, the scope of the invention should be limited only by the attached claims. It is therefore contemplated that the appended claims will cover any such modifications of the embodiments as fall within the true scope and spirit of the invention.

What is claimed is:

1. A method for operating a handheld calculator comprising a controllable power domain, the method comprising:
receiving, by the handheld calculator, a signal to power down the handheld calculator;
storing context information of at least one component in the controllable domain in an external memory;
setting a boot indicator to indicate a quick boot on power up; and
removing power from the controllable power domain.

2. The method of claim 1, further comprising setting the external memory to a minimum power state that retains memory contents prior to removing power from the controllable power domain.

3. The method of claim 1, further comprising:
computing validation information for at least one portion of the external memory; and
storing the validation information in a memory that remains powered when power is removed from the controllable power domain.

4. The method of claim 1, further comprising:
receiving, by the handheld calculator, a signal to power up the handheld calculator;
restoring power to the controllable power domain;
restoring the context information of the at least one component in the controllable power domain from the external memory; and
resuming operation of the handheld calculator.

5. The method of claim 4, further comprising setting the external memory to an operational power state.

6. The method of claim 4, further comprising:
validating at least one portion of the external memory prior to restoring the current state, the validating based on validation information computed when the handheld calculator was powered down; and
performing a cold boot when the at least one portion is not valid.

7. The method of claim 4, further comprising:
checking the boot indicator to determine if a quick boot is to be performed prior to restoring the context information; and
performing a cold boot when the boot indicator indicates that a quick boot is not to be performed.

8. A method for operating a handheld calculator comprising a controllable power domain, the method comprising:
receiving, by the handheld calculator, a signal to power up the handheld calculator;
restoring power to the controllable power domain;
restoring context information of at least one component in the controllable power domain from the external memory, wherein the context information was stored in the external memory when the handheld calculator was powered down; and
resuming operation of the handheld calculator.

9. The method of claim 8, further comprising setting the external memory to an operational power state from a power state that retains memory contents when power is removed the controllable power domain.

10. The method of claim 8, further comprising:
validating at least one portion of the external memory prior to restoring the context information, the validating based on validation information computed when the handheld calculator was powered down; and
performing a cold boot when one or more of the selected sections is not valid.

11. The method of claim 8, further comprising:
checking a boot indicator to determine if a quick boot is to be performed prior to restoring the previous state; and
performing a cold boot when the boot indicator indicates that a quick boot is not to be performed.

12. The method of claim 8, further comprising:
receiving, by the handheld calculator, a signal to power down the handheld calculator;
storing context information of at least one component in the controllable power domain in the external memory;
setting a boot indicator to indicate a quick boot on power up; and
removing power from the controllable power domain.

13. The method of claim 12, further comprising setting the external memory to a minimum power state that retains memory contents prior to removing power from the controllable power domain.

14. The method of claim 12, further comprising:
computing validation information for at least one portion of the external memory; and
storing the validation information in a memory that remains powered when power is removed from the controllable power domain.

15. A handheld calculator comprising:
a controllable power domain, the controllable power domain comprising a processor, and an external memory controller;
a non-controllable power domain, the non-controllable power domain comprising a power management unit configured to control power to the controllable power domain; and
an external memory coupled to the external memory controller, the external memory configurable to operate in a minimum power state that retains memory contents when power is removed from the controllable power domain and in an operational power state when the controllable power domain is powered,
wherein the handheld calculator is configured to perform a method comprising:
receiving a signal to power down the handheld calculator;
storing a current context of the processor in the controllable power domain in the external memory;
setting a boot indicator to indicate a quick boot on power up; and
removing power, by the power management unit, from the controllable power domain.

16. The handheld calculator of claim 15,
wherein the controllable power domain further comprises a memory and at least one device controller, and
wherein the method further comprises storing contents of the memory and a current context of the at least one device controller in the external memory.

17. The handheld calculator of claim 15, wherein the method further comprises setting the external memory to the minimum power state prior to removing power from the controllable power domain.

18. The handheld calculator of claim 15, wherein the method further comprises:
computing validation information for a selected portion of the external memory; and
storing the validation information in a memory in the non-controllable power domain.

19. The handheld calculator of claim 15, wherein the method further comprises:
receiving, by the handheld calculator, a signal to power up the handheld calculator;
restoring power to the controllable power domain by the power management unit;
restoring the current context of the processor from the external memory; and
resuming operation of the handheld calculator.

20. The handheld calculator of claim 19, wherein the method further comprises:
validating a selected portion of the external memory prior to restoring the current context, the validating based on validation information computed when the handheld calculator was powered down; and
performing a cold boot when the selected portion is not valid.
